(19) United States
(12) Patent Application Publication
(10) Pub. No.: US 2001/0011238 A1
(43) Pub. Date: Aug. 2, 2001

(54) DIGITAL RIGHTS MANAGEMENT SYSTEM

(76) Inventors: MARTIN FOREST EBERHARD, WOODSIDE, CA (US); MARC EVAN TARPENNING, PALO ALTO, CA (US); WILLIAM KENJI MORROW, SAN FRANCISCO, CA (US); BRIAN SLESINSKY, SAN FRANCISCO, CA (US); LANCE UYEHARA, FREMONT, CA (US)

Correspondence Address: Kevin T. LeMond, TOWNSEND and TOWNSEND and CREW LLP, Two Embarcadero Center, 8th Floor, San Francisco, CA, 94111, US

(21) Appl. No.: 09/168,000

(22) Filed: Oct. 7, 1998

Related U.S. Application Data
(63) Continuation-in-part of application No. 09/034,720, filed on Mar. 4, 1998.

(51) Int. Cl. G06F 17/60

(52) U.S. Cl. 705/27; 705/26

(57) ABSTRACT

A secure content delivery system which is particularly useful for network distribution of electronic books includes a reader capable of storing encrypted text files downloaded from a content server such as a publisher's server. The system includes software processes operating over the network to execute purchase, authentication and downloading aspects of a transaction.

### BACKGROUND OF THE INVENTION

Quite possibly the most significant invention in the history of man is the development of the printing press. Generally attributed to Gutenberg, the printing press revolutionized the manner in which the printed word was distributed. Since then, the printed word has enabled virtually the entire world to share information.

Out of the invention of the printing press has grown the entire publishing industry, which affects—either directly or indirectly—nearly every person in the industrialized world. A significant portion of the publishing industry is related to the authoring and publishing of books. These books cover an extremely broad spectrum of topics, from pure entertainment to highly technical reference works.

Many people regard reading as a fundamental form of entertainment, and a common thread among educated people is a love of books. In nearly any crowd it can be expected that a significant percentage will have one or more books at hand at any one time. Many vacationers and other travelers can be seen carrying an assortment of books or other printed works, and a similar number of business travelers can be found to have a book tucked away for their spare moments.

However, one limitation of conventional books is that they are bulky and heavy. Although paperback books have simplified the bulkiness issue, they do so at the expense of readability. Hardcover books, while more readable, are heavier, bulkier and more costly. Either form represents a tremendous use of natural resources, as both require substantial amounts of paper and are seldom recycled when thrown away. While many books are resold once read, the vast percentage of used books are either thrown away or sit, unused, on the owner's shelves.

From the point of view of the author and the publisher, the used book market also represents a loss of potential revenue. If such used books were not available, at least some of those purchasing on the secondary market would purchase the book new. Because publishers and authors have no possibility to generate revenue from such used book sales, publishers have tended to increase their book prices to compensate for the lack of downstream revenue.

Another difficulty with conventional books is the cost of distribution. An entire segment of the transportation industry is directed to book distribution, and the process of selling a simple book typically involves multiple middlemen. Naturally, the costs associated with such distribution are passed along to the consumer and add significantly to the purchase price of a book.

Yet another limitation of the existing book publishing industry is that the costs associated with printing and distributing a book limits the variety of books offered to the public. Book publishers, who must shoulder such costs at least initially, often are necessarily loathe to take chances on new authors since they have an obligation to their shareholders to generate a profit. As a result, many new authors fail to achieve public awareness of their work, and the public never has the chance to judge for itself the work of such authors.

### SUMMARY OF THE INVENTION

The present invention overcomes many of the limitations of the prior art and, more particularly, provides a secure system for distributing valuable content to authorized recipients. In many embodiments, the content will be copyrighted and will be encrypted for protection against unauthorized copying. Still further, the distribution system may include a standalone reading device displaying the distributed content as clear text or other suitable format. The present invention may thus be thought of as a system and method for digital rights management.

In an exemplary embodiment, the distribution system is configured to distribute content such as the text of novels or other books. This content is typically protected by copyright and the electronic file of the content is carefully protected by the publisher or other copyright holder. The electronic files of the content typically reside on a server maintained by the publisher, and are distributed only after careful precautions (such as encryption) have been taken to ensure maintenance of the proprietary aspects of such files. In general, publishers are extremely reluctant to permit any other entity to maintain custody of such content in a non-encrypted format and generally decline to either license or otherwise relinquish control over such content.

To ensure protection of the publisher's rights, the distribution system of the present invention incorporates the publisher's server on which the content is stored. In addition, the hardware included with the distribution system may include a reader, a user's personal computer, a retailer's server, and an authentication server. The reader is typically a standalone device capable of storing and selectively displaying the text of a quantity of books, such that the user need carry only a single reader to be able the read a large volume of books. The reader typically includes decryption logic for displaying as clear text the encrypted files received from the publisher. Further, the reader is typically connected to a user's PC during downloading of the content from the PC. The user typically requests a book through software resident on the PC; for example, a browser with a secure socket layer, or in some cases a Java applet, operating on the user's PC will permit the user to send a purchase request to a retailer. In a typical embodiment, the request will be encrypted. In at least a number of embodiments of the system, the reader itself will be identified by an electronic ID, and the electronic ID of the reader will be provided to the retailer as discussed hereinafter.

The user's PC is typically connected, at least intermittently, to a retailer (for example, Amazon.com) who maintains a server suitable for executing commercial transactions. The connection between the user's PC and the retailer's server may be, for example, over the Internet, and in such a context the commercial transaction will typically be a secure credit card or other electronic funds transaction. In at least some implementations, the retailer server may be incorporated into another of the servers included in the distribution system. The retailer server serves as an intermediary to the appropriate publisher server and/or the authentication server, and passes the order information along to the upstream portions of the distribution system once the commercial transaction has been completed.

The authentication server referred to above as part of the distribution system provides a plurality of functions. First, it maintains a database of the electronic IDs, or keys, of the various readers. Second, it authenticates requests from those readers; third, it keeps track of purchases and accounting information for each of the readers; and, fourth, it maintains a per country database of the publisher of each book. The authentication server typically passes to the appropriate publisher server (e.g., the publisher server for the applicable publisher for a specified country) a confirmed request for the file which represents the electronic version of the book requested by the user. Once the request is acknowledged by the publisher server, the publisher server then downloads to the user's PC the electronic file in encrypted form. The encryption is typically customized for the electronic ID of the particular reader, so that the encrypted file can only be displayed as clear text on the requesting reader. In addition, in a currently preferred embodiment, the user's PC is not capable of decrypting the file, so that no clear text version of the book exists anywhere but the publisher's server. In some embodiments, the PC may be eliminated entirely by providing the reader with the ability to access the Internet and browser software. Alternatively, the PC may be provided with limited decryption capability.

It will be appreciated that, although a single publisher server is discussed herein as part of the exemplary embodiment, in fact multiple such servers may be used—including one or more servers at each of several publishers.

Many additional features can also be implemented in the distribution system. For example, the authentication server can maintain a list of all titles bought by a particular reader. In the event a particular reader is either damaged or lost, or the customer simply desires remote access while away from his usual PC, the owner of that reader can request replacement copies of the books downloaded to that reader. The authentication server can also provide a clearinghouse for all reader transactions, including assisting the user in making future selections by maintaining a record of the types of books preferred by that user.

These foregoing summary of the present invention may be better appreciated from the following Detailed Description of the Invention, taken together with the attached Figures.

### FIGURES

FIG. 1 shows an exemplary implementation of a distribution system in accordance with the present invention.

FIG. 2A shows in flow diagram form an exemplary implementation of a transaction.

FIG. 2B shows in block diagram form an alternative and presently preferred implementation of a transaction.

FIG. 3 shows in flow diagram form an exemplary title verification process.

FIG. 4 shows in perspective view a reader according to the present invention.

FIG. 5 shows in block diagram form an exemplary implementation of a reader in accordance with the present invention.

### DETAILED DESCRIPTION OF THE INVENTION

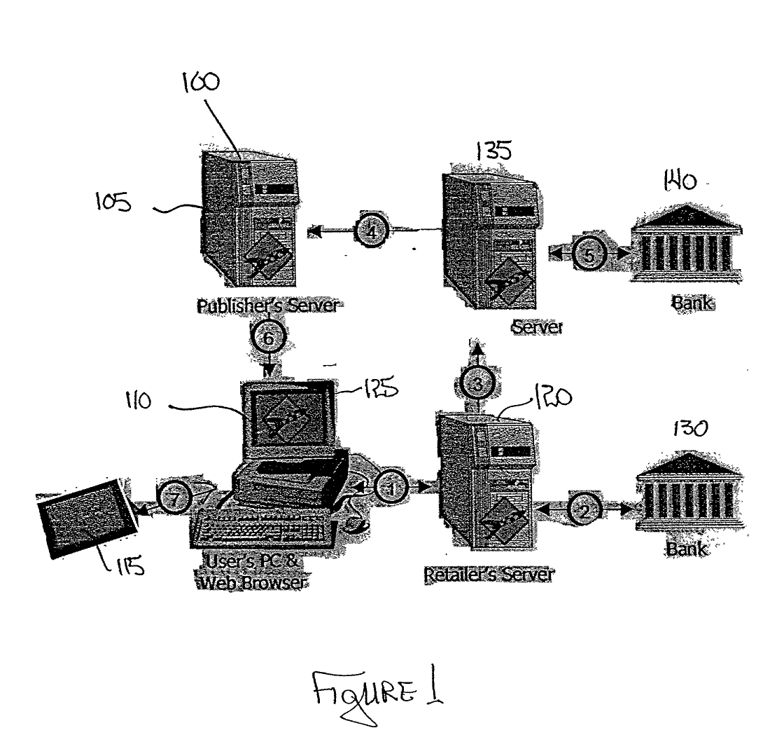

Referring first to FIG. 1, a distribution system 10 in accordance with the present invention can be better appreciated. A publisher server 100 contains thereon one or more files of content 105 such as the text of books. The files 105 are typically maintained in cleartext form on the publisher server 100, although in some embodiments the files of content may be maintained in encrypted form. In other embodiments the publisher server 100 may include an encryption process for securing content files before such files are transmitted in the manner described hereinafter.

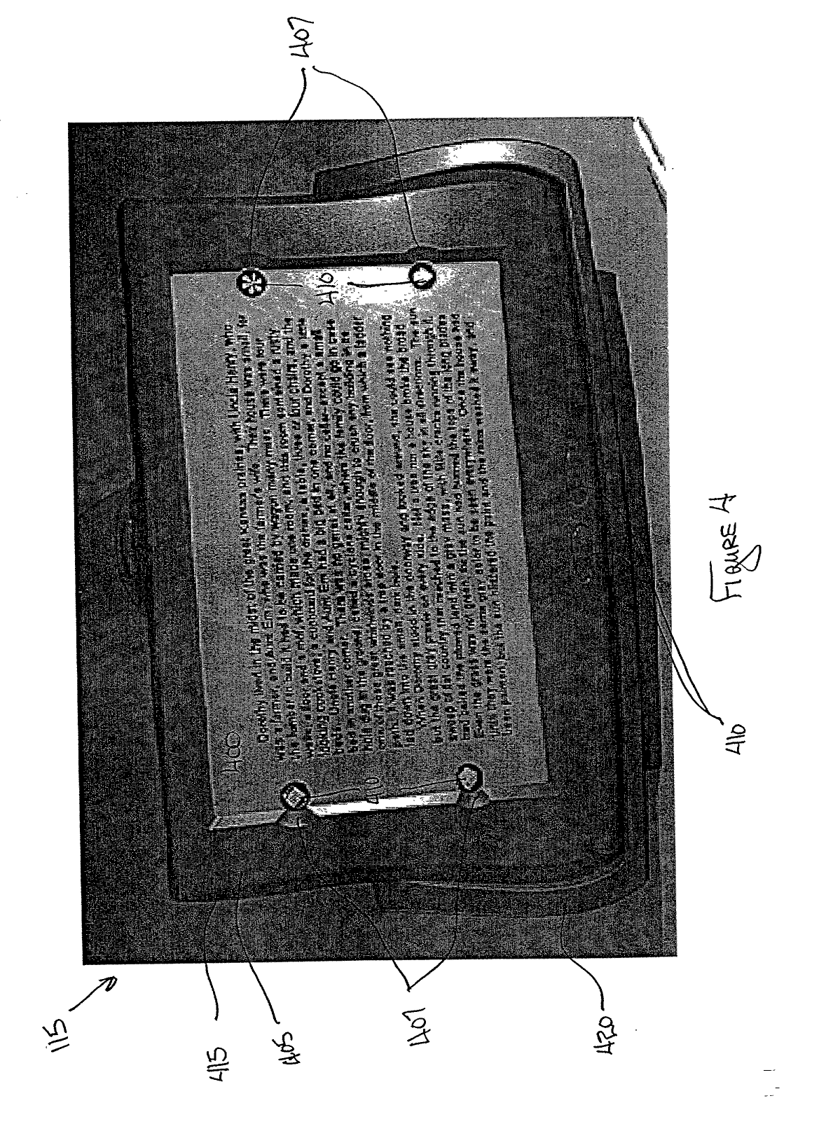

A user PC 110, typically configured with Internet access and suitable front-end software 112 such as a Web browser (for example, Netscape™ or Microsoft Explorer™, communicates with a text reader 115 as well as a retailer server 120. The reader 115 may be of the type described in connection with FIG. 4 hereof. As described in greater detail hereinafter, the reader 115 is typically identified by a unique indicia such as a serial number 117 and in a typical embodiment also includes a private encryption key 119 which may be uniquely associated with either a specific reader or a specific customer. In addition to the browser 112, the user PC typically has installed application software such as a Java applet or a helper application 125 which cooperates with a browser by querying the reader 115 to extract the reader serial number or other customer ID 117. The PC 110 may be rendered unnecessary in some embodiments by including in the reader 115 browser software and the ability to access the Internet.

The customer then browses a retailer's server 120 (for example, Amazon.com) and identifies selected books that the user wishes to purchase in electronic form. Once the customer begins the purchase transaction for the identified books (which typically includes providing ISBN numbers or other sufficient information to uniquely identify the book), the applet or helper application 125 provides the customer or reader specific indicia 117 to the retailer's server. Alternatively, this information can be entered manually, or could be stored as a cookie or on the server 120. Still further, the helper application 125 could be implemented as a plug-in, although plug-ins tend to be browser-specific and more complicated as a result. Regardless of the specific implementation, the retailer's server 120 is supplied with customer-specific indicia which permits subsequent authentication of the purchase and verification of the purchaser. In some, though not all, the IP address of the user's PC may also be provided to the retailer server as part of the transaction. In addition, the user supplies appropriate payment information which may be, for example, a credit card number or other Internet-capable payment scheme.

The retailer server 120, which may be any form of Internet-connected server, responds to a purchase request from a user by executing payment with an associated financial institution 130 such as a bank or other credit clearing house. In addition, the ID of the reader and the indicia of the requested publication (e.g., ISBN number) is supplied to an authentication server 135. In a presently preferred embodiment, the authentication server 135 provides several key functions including maintenance of a database of the electronic IDs, or keys, of the various readers. Also, the server 135 maintains a database identifying the publisher for a given ISBN number, including country in which the customer's reader is located. In addition, the authentication server 135 authenticates requests from those readers by ensuring that the ID received as part of a particular transaction matches the user maintained in the database. Further, the authentication server maintains a database of all purchases and related accounting information for each of the readers. One advantage of such an arrangement is that, if a reader 115 fails or the content stored therein is erased, the database maintained by the server 135 can automatically arrange for replacement of the downloaded text in a manner described hereinafter. In addition, in at least some embodiments, the authentication server will execute a financial transaction with a bank 140 or other clearing house. The authentication server 135 typically passes to the publisher server 100 a confirmed request for a file 105 which represents the electronic version of the book requested by the user.

At this point the transaction is complete but for supplying the electronic file to the customer's reader. In some instances, the customer may not wish to immediately download the file; in others, the customer may want an immediate download. If no download is requested, the process essentially terminates until a download is requested. Once a download is requested—which may come hours, days, weeks or more later—the request is acknowledged by the publisher server 100. At that point, the publisher server downloads the encrypted file 105 to the user's PC 110, via the plug-in or helper application 125; a web browser may also be used in at least some embodiments. The encryption is typically customized for the electronic ID of the particular reader 115, typically using the key or ID uniquely associated with that reader, so that the encrypted file can only be displayed as clear text on the requesting reader 115. In addition, in a currently preferred embodiment, the user's PC is not capable of decrypting the file, so that no clear text version of the book exists anywhere but the publisher's server. In this manner, copyright violations are avoided and the rights of the publisher are protected. In some instances, such as for works in the public domain, it may be desirable not to use encryption, in which case the encryption/decryption steps are simply eliminated.

With the aid of the helper application 125, the user's PC stores the encrypted file 105 until the associated reader 115 establishes a communications link through any suitable protocol, including serial, parallel, USB, twisted pair, or infrared. The file is then downloaded to the reader 115, where appropriate decryption occurs and permits the file to be displayed as clear text.

In an important feature, the distribution scheme of the present invention never requires that the content represented by the file 105 be licensed to any intermediate holder; that is, neither the retailer server nor the authentication server need have any control over or custody of the content, which passes solely between the publisher server 100 and the user PC 110. In a presently preferred embodiment, the file 105 is maintained in encrypted form, although such encryption may not be required for all files 105. Nevertheless, for those files that are encrypted, the publisher or other copyright holder can be assured that unauthorized copies will not exist. In some embodiments, it may also be desirable to configure the reader 115 to decrypt only a page of text currently being displayed, so that the remaining text is maintained in fully encrypted form even within the reader 115.

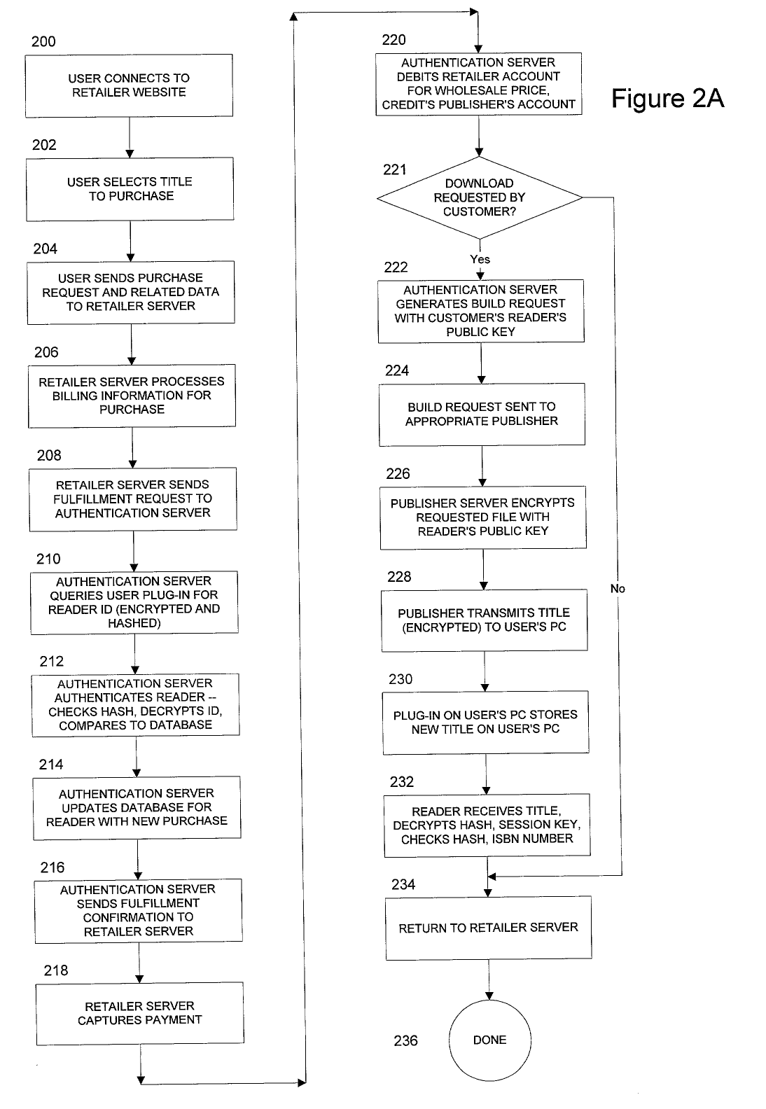

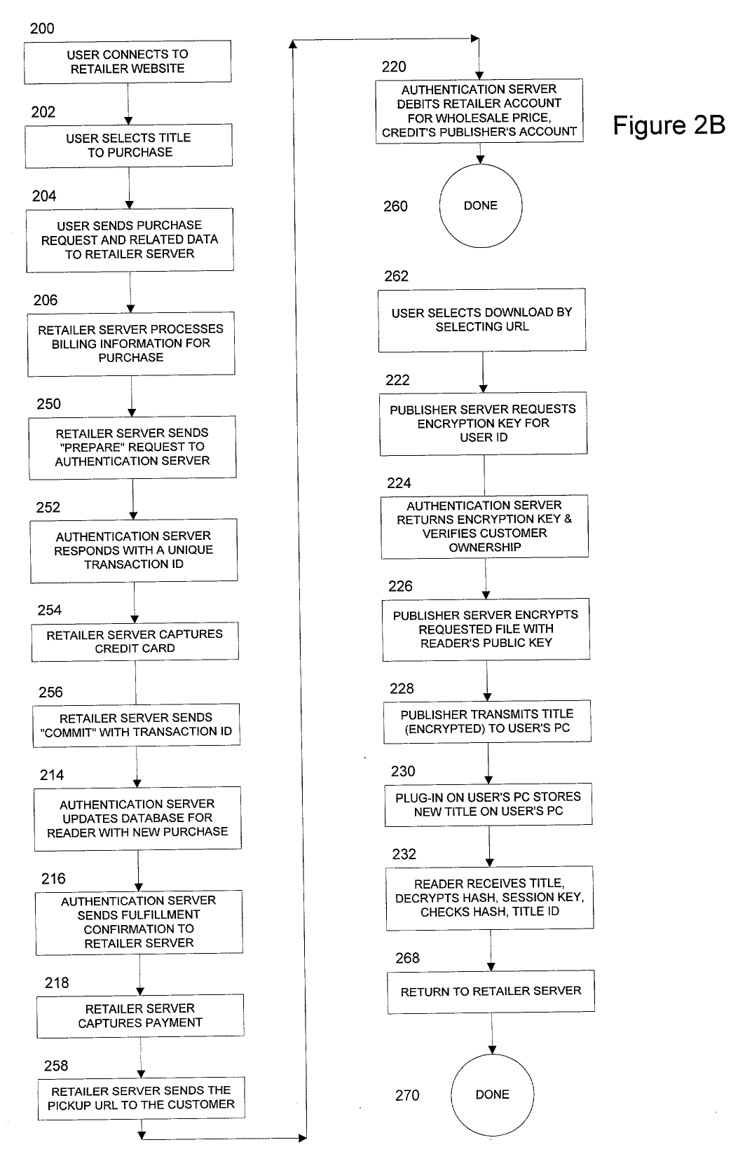

Referring next to FIGS. 2A and 2B, the events associated with a single transaction may be appreciated in greater detail. Referring first to FIG. 2A, and beginning at step 200, the user connects to a retail Web site such as amazon.com, which allows the user to peruse the variety of books available for purchase. The user then selects one or more titles at step 202, and at step 204 sends a purchase request, typically over a network connection but any suitable communications link is acceptable. The purchase request of step 204 is typically a unique identifier such as an ISBN number, as noted previously, and is accompanied by customer and/or reader identification information and payment authorization.

At step 206 the retailer server seeks authorization to charge the customer's account for the amount of the retail purchase, which directs the browser 112 to attach to the appropriate server for an Internet-based transaction, and otherwise processes the billing information associated with the purchase. At step 208 retailer server sends a fulfillment request to the authentication server. In response, at step 210 the authentication server obtains the user's reader ID from the retailer server as part of the fulfillment request although the other alternatives discussed previously are also acceptable. In at least some embodiments, the reader ID is encrypted and hashed. In others, the reader ID may be looked up in a database, for example a database including customer information. At step 212 the authentication server checks the hash and decrypts the ID, after which the ID is compared to the reader ID database maintained on the authentication server.

Assuming the ID and related data are confirmed by the authentication server, at step 214 the server updates its database to identify the new purchase in the database for the associated reader. At step 216, the authentication server sends back to the retailer server a fulfillment confirmation, which causes the retailer server to complete the capture of payment from the user's credit card or other account at step 218. In some embodiments, such as the alternative embodiment discussed hereinafter in connection with FIG. 2B, the message from the authentication server may include a URL or other pointer to a web or network location from which the customer may download the titles or other data. In addition, such other embodiments may include “pre-purchase” and “commit purchase” steps to facilitate various database operations.

Continuing with reference to FIG. 2A, at step 220 the authentication server debits the retailer account (now enriched by the retail amount of the book) for the wholesale price of the book or other content, and credits the publisher's account by an appropriate amount. Typically, the publisher's account is credited for less than the total wholesale price of the book, such that a difference exists. That difference is then credited to the account of the operator of the authentication server.

As noted previously, the user has the option to request a download of his new purchases or any previous purchases. A feature of the present invention is that any titles owned by a customer can be downloaded at any time. At step 221, the process checks to determine whether the user has requested a download.

When a user requests a download, the authentication server generates a build request at step 222, identifying the file(s) requested and the reader's public key. In other embodiments, it may be preferred to permit the user to download the data from a publisher. In such an embodiment, the publisher server responds to such a user request by requesting the encryption public key for the particular reader. The authentication server then confirms ownership of the titles and transfers to the publisher server the reader's public key. A security field may also be included, and may comprise an encrypted form of the book, the customer identifier and the reader ID. In an exemplary embodiment, the security field is bound into the encrypted file and is used in the reader 115 to assist in authenticating the transaction. At step 224, the Build request (or, in some embodiments, authorization) is sent to the appropriate publisher server, which in turn (step 226) encrypts the requested file with the reader's public key or ID, and forwards the now-encrypted file to the user PC at step 228. The plug-in or helper app 125 on the user's PC then causes the file to be loaded in the user's hard drive in encrypted form at step 230.

Finally, at step 232 the user connects the reader 115 to the PC, which permits the title to be downloaded to the reader. The reader, as part of the receipt process, decrypts the hash and session key, checks the hash and security field information to confirm a valid download, and then prepares the new file for display on the reader. The process then returns to the retail server at step 234, and completes at step 236. In the event a “NO” response resulted at step 221, the process jumps from step 221 to step 234 and then completes at step 236 as before.

An alternative, and presently preferred, implementation of the transaction process is shown in FIG. 2B. The process is similar in many respects to the transaction process of FIG. 2A; as a result, like steps are given like numbers. In particular, steps 200 through 206 are unchanged from FIG. 2A. However, in response to the processing of billing information for the purchase by the retailer server at step 206, the process of FIG. 2B advances to step 240 where the retailer server sends a “prepare” request to the authentication server, which causes the authentication server to respond at step 252 with a unique transaction ID which is sent to the retailer server. The retailer server then captures a buyer's credit card information at step 254, and at step 256 the retailer server sends a “commit” message with the unique transaction ID received from the authentication server in step 252.

The process then continues at step 214, as discussed above in connection with FIG. 2A, where the authentication server updates the database for the user's reader with the new purchase. The authentication server then sends a fulfillment confirmation to the retailer server at step 216, and the retailer server captures payment at step 218.

Thereafter, at step 258, the retailer server sends to the user a “pickup” location, such as a URL, from which the user can download the newly-purchased text or other data. The authentication server then debits the retailer account for the wholesale price of the book or other data, and credits the publisher's account for the appropriate amount. Unlike the process shown in FIG. 2A, the process of FIG. 2B then completes a first phase at step 260 until the user decides to download the purchased title or titles.

Once the user determines to download the title or titles purchased through the foregoing process, the second phase process of FIG. 2B initiates, and at step 262 the user begins the download process by selecting the URL or other location provided in the message sent at step 258. The process then continues in a matter substantially identical to that shown in FIG. 2A, with the publisher server requesting the encryption key for the user ID at step 222, the authentication server returning the encryption key and verifying customer ownership at step 224. At step 226 the publisher server encrypts the requested file with the reader's public key, while at step 228 the publisher server transmits the title in encrypted form to the user's PC. The plug-in, or helper application on the user's PC then stores the new title on the PC, which permits the user, at step 232, to receive the title or other data, decrypt it, and read the title. The second phase of the process then advances to step 268 where it returns to the retailer server, and then completes at step 270.

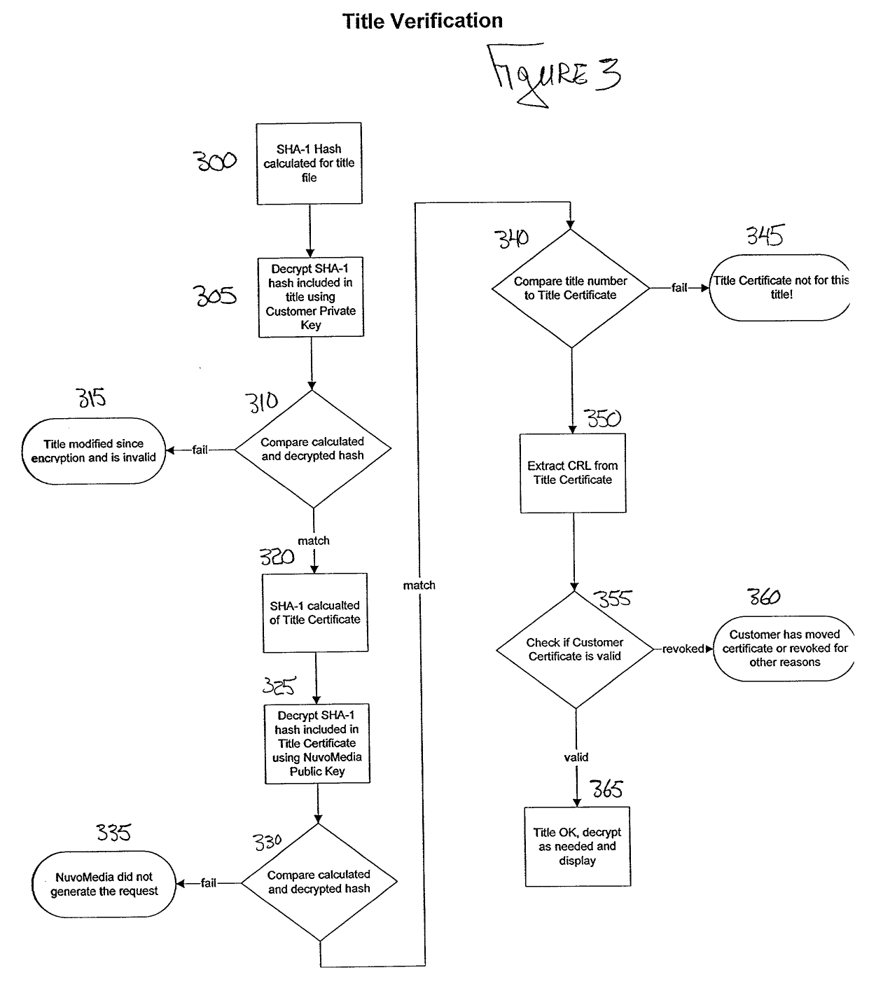

Referring next to FIG. 3, the process by which the hash and security field information is generated and verified can be better understood. The title verification process shown in FIG. 3 begins at step 300 by a hashing calculation, which may for example use a SHA-1 algorithm, to calculate a hash for a title file downloaded from the publisher's server. At step 305, the SHA-1 hash included in the title is then decrypted using the Customer Private Key discussed above. At step 310, the calculated hash from step 300 is then compared with the decrypted hash generated as step 305. If the two do not match, the title verification fails at step 315.

However, if the compare is successful and the two hashes match, the process advances to step 320 and the Title Certificate is then verified in a manner similar to the title file process just described. At step 320, the SHA-1 hash is calculated for the Title Certificate provided as part of the title file. The SHA-1 hash for the Title Certificate is then decrypted at step 325 using the public key of the authentication server, for example the public key of the assignee of the present invention. The calculated and decrypted hashes for the Title Certificate are then compared at step 330, and a mismatch causes the process to terminate at step 335. A mismatch would typically result if the request for a transaction did not originate from an authorized party such as the operator of the authentication server.

If the calculated and decrypted hash match, the process advances to step 340 where the title number is compared to the Title Certificate. If the compare fails, it is assumed that the Title Certificate is not for the same title as the title number and the process terminates at step 345. If the compare succeeds, the process continues at step 350 by extracting the CRL or certificate revocation list from the Title Certificate of the downloaded file. At step 355, the CRL (which is used to eliminate rogue certificates) is checked against the customer certificate maintained in the reader 115. If not, the process terminates at step 360. This early termination usually results where the customer has moved the certificate improperly, or the customer certificate has been revoked for other reasons. If the customer certificate is valid, however, the title is fully verified and the process advances to step 365 by permitting the file to be decrypted as needed for display to the customer.

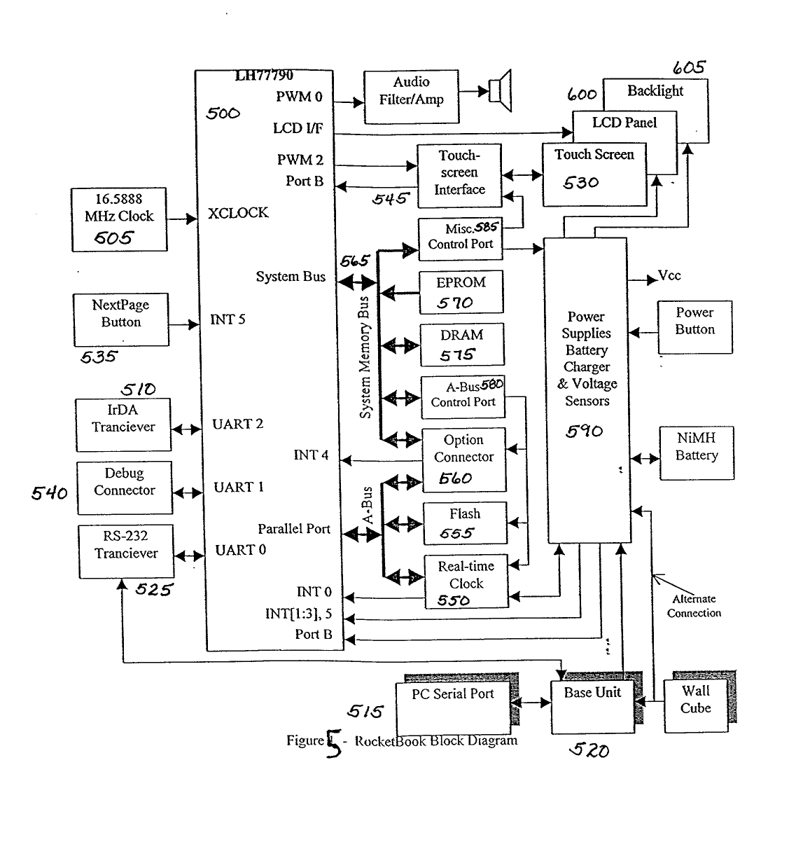

Referring now to FIG. 4, the reader 115 of the present invention may be better understood. The reader 115 is typically a compact, handheld device having a screen 400 surrounded by a bezel 405. A series of indentations 407 in the bezel 405 may be conveniently located around the edge of the screen 400, and a series of user-actuable buttons 410 may be located either in the bezel or as touch-sensitive portions of the screen 400. The indentations permit a user to readily identify a “home position” of the reader in any orientation, and the buttons permit data to be displayed in either a landscape or portrait mode, in larger or smaller size, or other features including attaching notes or highlighting of displayed text. Buttons may also be provided for other functions, including management of personal information, a calculator, or Internet access. The reader 115 includes logic described in greater detail in connection with FIG. 5, which logic is typically included on a single logic board (not shown) enclosed within a case 415. The reader typically sits in a base unit or cradle 420 which can provide data interface, power and charging functions as well as providing a convenient reading support for the reader 115.

Next referring to FIG. 5, the schematic block diagram of the reader 115 may be better appreciated. The reader comprises a CPU 500 and may for example be a Sharp LH77790 device, which includes an ARM-7 CPU core as well as 2K cache, 2K general purpose RAM, three UARTs, an LCD panel controller, three counter-timers, three PWMs, an interrupt controller, a memory controller for external DRAM and or other memory such as SRAM or PROMs, and a 24-bit parallel port. A clock crystal 505 provides a clock signal of a suitable frequency, for example on the order of 16.5888 MHz. Input to the reader 115 can be provided through an IrDA transceiver 510, a serial port 515 connected through a base unit 520 and an RS232 transceiver 525, a touch screen 530 and buttons 410 including “NextPage” button 535. Analytical input and output may be had through debug connector 540, which connects to one of the UARTs in the CPU 500. The touchscreen 530 will typically interface to the CPU 500 through a touchscreen interface 545.

A variety of devices may be connected to the parallel port of the CPU 500, including a real-time clock 550, FLASH RAM 555, and an option connection 560 (which may also connect to an Interrupt Request line INT4 of the CPU 500. Likewise, a variety of devices may be connected to the system bus 565 of the CPU 500, including EPROM 570, DRAM 575, A-Bus Control Port 580 and Option Connector 560. The system bus 565 may also provide output to a Misc. Control Port 585, which in turn provides data to the touchscreen interface 545 and power supply/voltage sensor block 590. Output from the CPU, including text display of the files or books, can be displayed on LCD panel 600, which may cooperate with a backlight 605. Conventional controls and power supplies such as power button 610, battery 615 and wall cube transformer 620 may also be provided.

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

We claim:

1. A distribution system for delivery of secure content from a repository of such secure content to a user comprising
a user system for communicating a request to receive secure content as specified by a user,
an authorization server responsive to requests from a user system for authenticating requests for secure content from a user system,
a first server having stored thereon at least one file of secure content and responsive to an authorized request for delivery of such file,
a communications link from the first server to a user system for delivering secure content.

2. The distribution system of claim 1 wherein the user system includes
a reader for displaying the secure content as clear text,
a user host system for receiving secure content from the first server but incapable of displaying the secure content as clear text, and
a communications link for delivering secure content stored in the user host system to the reader.

3. A method for delivering secure content from a repository system to a user system including the steps of
generating, at a user system, a request for secure content,
receiving the request and generating an authorization signal in response thereto,
delivering the request for secure content to a repository system on which the requested secure content is stored,
delivering to the user system the secure content.

4. The method of claim 3 further including the step of displaying the content for viewing by a user.
